(19) United States
(12) Patent Application Publication
(10) Pub. No.: US 2009/0015546 A1
(43) Pub. Date: Jan. 15, 2009

(54) Electro-optic display device

(75) Inventors: Uk-Chul Choi, Cheonan-si (KR); Seong-Sik Shin, Seongnam-si (KR); Cheol-Woo Park, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/217,964

(22) Filed: Jul. 9, 2008

(30) Foreign Application Priority Data
Jul. 9, 2007 (KR) 10-2007-0068799

(51) Int. Cl. G09G 3/34

(52) U.S. Cl. 345/107

(57) ABSTRACT

There is provided an electro-optic display device which can be used in a folder type or in a roll type. The electro-optic display device comprises a substrate including an electro-optic layer having charged color particles and including a gate line and a data line; a timing controller for generating a control signal according to a signal applied from an external unit; and a driving integrated circuit disposed on one side of the substrate, the driving integrated circuit having a gate driver and a data driver for receiving the control signal from the timing controller and for respectively driving the gate line and the data line.

### CROSS-REFERENCE TO RELATED APPLICATION(S)

This application claims priority of Korean patent application 2007-0068799, filed on Jul. 9, 2007, the entire disclosure of which is incorporated herein by reference.

### BACKGROUND OF THE INVENTION

1. Technical Field

The present disclosure relates to an electro-optic display device, and more particularly, to a portable electro-optic display which can be used in a folder type or in a roll type.

2. Discussion of Related Art

Information display devices are of significant importance. The conventional electro-optic display device is capable of providing a comfortable feeling similar to paper because the device has high reflectivity, high contrast, and little dependence on field-of-view angle. In addition, the electro-optic display device has the characteristic that the black or white state is bistable, and so the device is capable of maintaining an image without applying voltage continuously, thereby requiring less power. In addition, the electro-optic display device does not require a polarizing plate, an alignment film or a liquid crystal, thereby having considerable price competitiveness relative to a liquid crystal display.

A conventional electro-optic display device has a thin film transistor in the substrate, and so it is difficult to form the conventional device in a foldable or bendable shape. In the conventional electro-optic display, a device for driving the thin film transistor is formed on more than two side surfaces among 4 side surfaces of the substrate, thereby preventing the substrate from being bent or folded.

### SUMMARY OF THE INVENTION

The present disclosure provides an electro-optic display device which can be used in a folder type such as a book, or which can be bent or rolled like paper.

In an exemplary embodiment, the present disclosure provides an electro-optic display device comprising a substrate including an electro-optic layer having charged color particles and including a gate line and a data line; a timing controller for generating a control signal according to an externally applied signal; and a driving integrated circuit disposed on one side of the substrate, the driving integrated circuit having a gate driver and a data driver for receiving the control signal from the timing controller and for respectively driving the gate line and the data line.

The driving integrated circuit further comprises an output terminal unit for outputting signals of the gate driver and the data driver.

The output terminal unit has output terminals of the gate driver and the data driver which are alternately disposed, and the output terminals output signals in a same direction.

The gate line has a connection line to be connected to the output terminals.

The driving integrated circuit further comprises a power supply for supplying power to the timing controller, the gate driver, and the data driver.

The power supply outputs a positive gamma voltage, a negative gamma voltage and a ground level gamma voltage to the data driver.

The driving integrated circuit further comprises a receiving unit for receiving a signal from an external unit to transmit the signal to the timing controller.

The electro-optic display device further comprises a holder for receiving the substrate and the driving integrated circuit.

The holder comprises a first case having a cylindrical shape, a second case formed within the first case, and a rotation supporting axis for rotating the second case.

The holder comprises a control board connected to the driving integrated circuit and a power supply for supplying power to the control board and the driving integrated circuit.

The control board comprises a controller for receiving data and a voltage from an external unit and for controlling an operation of the substrate and an image displayed on the substrate.

The holder comprises a signal input/output terminal to be connected to the external unit.

The power supply comprises a battery.

In another exemplary embodiment, the present disclosure provides an electro-optic display device including first and second substrates having a gate line and a data line; a connection substrate formed between the first and second substrates; and a driving integrated circuit package mounted on the connection substrate and adapted to have two or more driving integrated circuits each including a gate driver and a data driver which respectively drive the gate line and the data line.

The electro-optic display device further comprises a control board for providing pixel data and a control signal to the driving integrated circuit package.

The driving integrated circuit package receives the pixel data and the control signal from the control board to output driving signals for driving the first substrate and the second substrate respectively.

The electro-optic display device further comprises a connector for providing connection between the control board and the driving integrated circuit package.

### BRIEF DESCRIPTION OF THE DRAWINGS

The above and other features and advantages of the present disclosure will become more apparent to those of ordinary skill in the art by describing in detail exemplary embodiments thereof with reference to the attached drawings in which:

FIG. 1 is a view illustrating an electro-optic display device according to an exemplary embodiment of the present disclosure.

FIG. 2 is a cross sectional view of the electro-optic layer according to the exemplary embodiment of the present disclosure.

FIG. 3 is a view illustrating the driving integrated circuit (IC) shown in FIG. 1.

FIG. 4A and FIG. 4B are views illustrating an electro-optic display device according to another exemplary embodiment of the present disclosure.

FIG. 5 is a view illustrating a control board shown in FIG. 4B.

FIG. 6A and FIG. 6B are views illustrating a front side and a back side of an electro-optic display device according to another exemplary embodiment of the present disclosure; and

FIG. 7 is a view illustrating the driving IC package shown in FIG. 6B in detail.

In the drawings, the thickness of layers and areas are exaggerated for clarity. Like numerals refer to like elements throughout.

### DETAILED DESCRIPTION

The present disclosure will now be described more fully hereinafter with reference to the accompanying drawings, in which exemplary embodiments of the disclosure are shown. Further, where the function and structure are well-known in the relevant arts, further discussion will not be presented in the detailed description or illustration of the present embodiments.

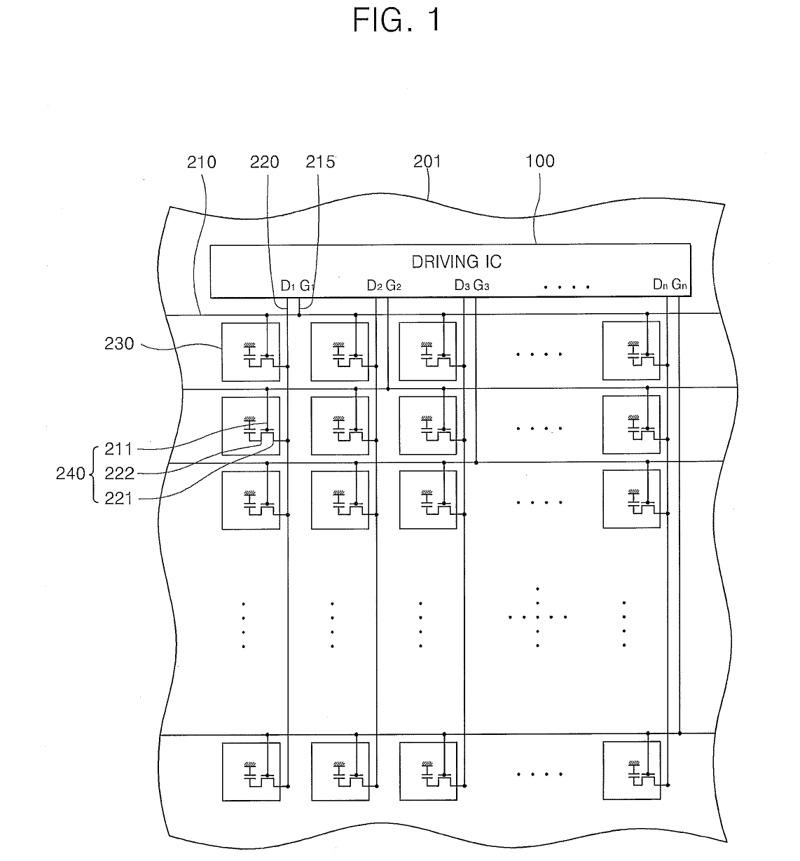

FIG. 1 is a view illustrating the electro-optic display device according to an exemplary embodiment of the present disclosure.

As illustrated in FIG. 1, the electro-optic display device includes a substrate 201, a first conductive line 210, a second conductive line 220, a pixel 230, a thin film transistor 240, and a driving integrated circuit (IC) 100.

The substrate 201 is formed with a plastic material so as to achieve thinness and a flexibility.

The first conductive line 210 is extended in a first direction of the substrate 201, for example a horizontal direction. In addition, the first conductive line 210 includes a connection 215 formed perpendicularly to the first direction so as to be connected to the driving IC 100. The connection 215 is formed to have 1 to nth lines, n being the number of lines of the first conductive line 210 so as to connect output lines of the driving IC 100 and the n first conductive lines 210. The first conductive line 210 receives a driving signal from the driving IC 100 through the connection 215. Here, the first conductive line 210 is a gate line.

The second conductive line 220 is extended in a second direction of the substrate 201, for example a vertical direction. In addition, the second conductive line 220 is connected to the driving IC 100 formed at an end of the second conductive line 220. First to Nth lines of the second conductive line 220 are connected to the driving IC 100. Accordingly, the second conductive line 220 receives a driving signal from the driving IC 100. Here, the second conductive line 220 is the data line.

The pixel 230 is formed near an intersection of the first conductive line 210 and the second conductive line 220. The pixel 230 is formed in a matrix form on the substrate. In addition, the pixel 230 comprises a thin film transistor 240 which is connected to the first conductive line 210 and the second conductive line 220.

The thin film transistor 240 is connected to the conductive lines 210 and 220 to control a driving of the pixel 230. Here, it may be to form the thin film transistor 240 with an organic transistor because of temperature limitation of the substrate 201.

For example, in the thin film transistor 240, a semiconductor layer which functions as a channel between the gate electrode 211 and source and drain electrodes 221 and 222 is formed of an organic material. Meantime, the thin film transistor 240 is not limited to the organic semiconductor, and the transistor may be formed of various materials according to the characteristics and the manufacture method of the electro-optic display device.

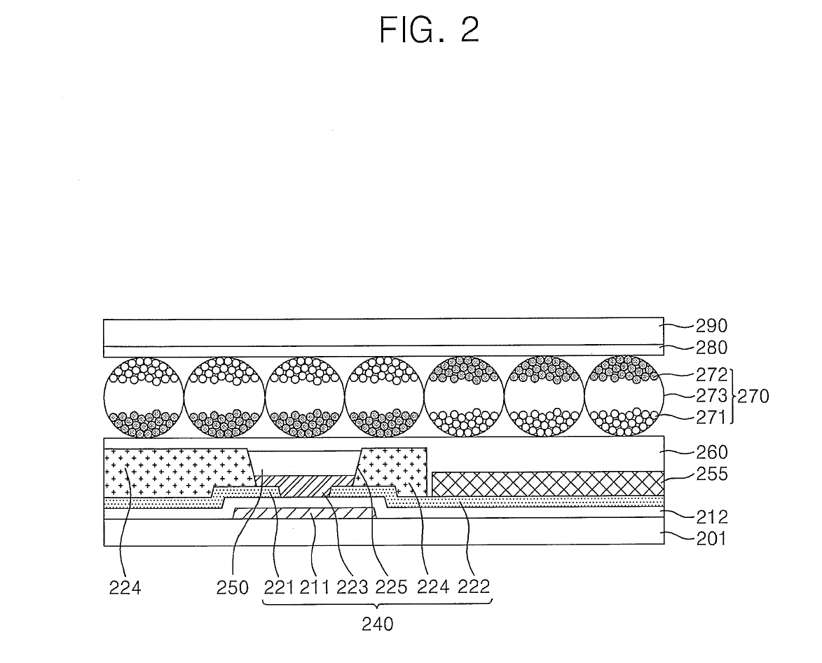

The thin film transistor 240 is described in detail with respect to FIG. 2, and an electro-optic layer is also described in FIG. 2.

FIG. 2 is a cross sectional view of the electro-optic layer according to the exemplary embodiment of the present disclosure.

As shown in FIG. 2, the electro-optic display device comprises the thin film transistor 240, a protective film 250, a first electrode 255, an electro-optic layer 270, a second electrode 280 and a protective substrate 290.

The thin film transistor 240 comprises a gate electrode 211, a gate insulating film 212, a source electrode 221, a drain electrode 222, a bank insulating layer 224 and a semiconductor layer 223. The gate electrode 211 is connected to the first conductive line 210 and overlaps the semiconductor layer 223 with the gate insulating film 212 disposed therebetween. Here, the gate insulating film 212 is formed on the whole surface of the substrate 201 so as to insulate the first conducting line and the gate electrode 211. The source electrode 221 is formed on the gate insulating film 212 to be connected to the second conductive line 220. The drain electrode 222 is formed opposite to the source electrode 221. The bank insulating layer 224 is formed on the source electrode 221 and the drain electrode 222 so as to form a hole 225. Here, the hole 225 exposes a part the source electrode 221 and the drain electrode 222.

The semiconductor layer 223 is formed above the gate electrode 211 in the hole 225 which is formed by the source electrode 221, the drain electrode 222 and the bank insulating layer 224. The semiconductor layer 223 may be formed of an organic semiconductor material such as polymer derivatives. Here, the semiconductor layer 223 is ohmically contacted with the source electrode 221 and the drain electrode 222 through the self assembly process. Specifically, the self assembly process results in a reduced work function difference between the semiconductor layer 223 and the source and drain electrodes 221 and 222. Accordingly, this makes it easy to form the semiconductor layer 223 in the hole, reducing the contact resistance of the semiconductor layer 223 with the source and drain electrodes 221 and 222. The thin film transistor 40 is protected by the protective film 250. The protective film 250 is formed on the hole 225 formed by the bank insulating layer 224 so as to protect the semiconductor layer 223 of the thin film transistor.

The first electrode 255 is connected to the drain electrode 222 of the thin film transistor 240 to receive pixel data from the thin film transistor 240. In detail, when voltage of a level corresponding to the pixel data is supplied through the thin film transistor 240, the first electrode 255 drives the electro-optic layer 270 arranged between the substrate 201 and the protective substrate 290.

The electro-optic layer 270 comprises micro capsules 273 having black and white charged color particles 271 and 272. This electro-optic layer 270 is attached to the substrate 201 by an adhesive layer 260. In the electro-optic layer 270, when the charged color particles 271 and 272 are arranged by an electric field between the first electrode 255 and the second electrode 280, the charged color particles 271 and 272 reflect light incident from the exterior to achieve color.

The second electrode 280 is formed of a transparent conductive material on the electro-optic layer 270. Accordingly, the second electrode 280 transmits light from the exterior to the electro-optic layer 270, and transmits light reflected from the electro-optic layer 270, thereby displaying images. In addition, when a common voltage is applied, the second electrode 280 forms an electric field with the first electrode 255 to arrange the charged color particles 271 and 272.

The protective substrate 290 is formed of a transparent insulating material on the second electrode 280, for example a film of material such as plastic. Accordingly, the protective substrate 290 protects the second electrode 280 and the electro-optic layer 270, and insulates the second electrode 280.

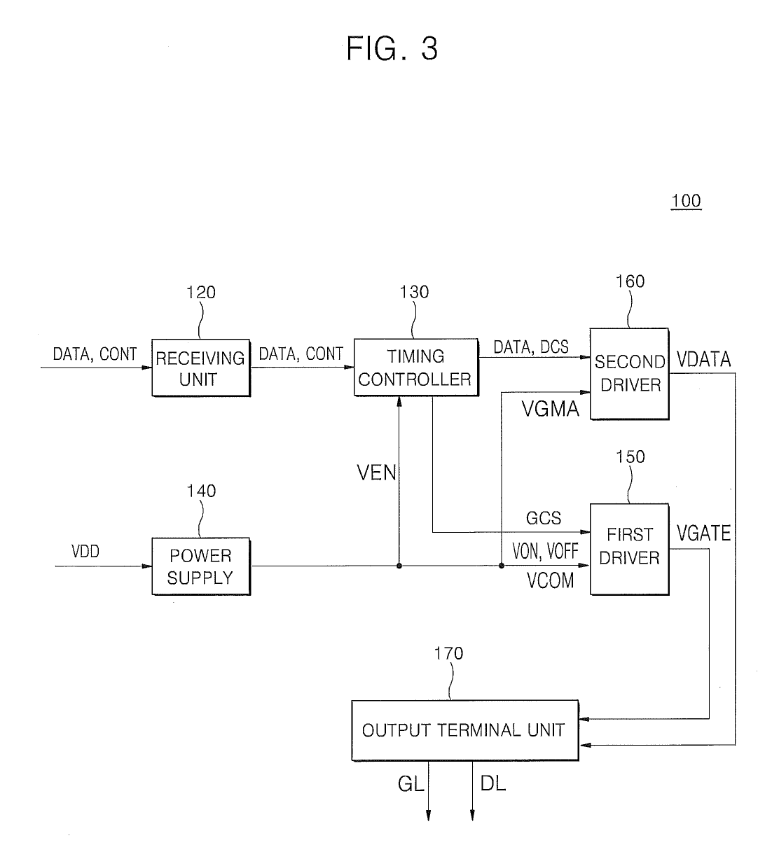

The driving IC 100 is described in detail with respect to FIG. 3.

FIG. 3 is a view illustrating the driving IC 100 shown in FIG. 1.

As shown in FIG. 3, the driving IC 100 includes a receiving unit 120, a timing controller 130, a first driver 150, a second driver 160, a power supply 140 and an output terminal unit 170.

The receiving unit 120 receives a control signal CONT and pixel data DATA, etc. from an external unit, and provides them to the timing controller 130. Here, the receiving unit 120 receives the signal from the external unit, for example, in a low voltage differential signaling (LVDS) method so as to reduce the electric noise.

The timing controller 130 produces first and second conductive line control signals GCS and DCS for controlling the first and second conductive lines 210 and 220, respectively. The timing controller 130 provides the pixel data DATA to the second driver 160. In order to reduce electric noise and minimize electric power consumption for a reliable transmission, the timing controller 130 may be capable, for example, of providing the control signals GCS and DCS and the pixel data DATA to the first driver 150 and the second driver 160 in reduced swing differential signaling (RSDS) method or mini LVDS method instead of Transistor-Transistor Logic (TTL). Alternatively, the timing controller 130 may be separately located outside the driving IC 100.

The power supply 140 converts power from the exterior into power required for the timing controller 130, the first driver 150 and the second driver 160. In detail, the power supply 140 converts the input power to an enable voltage VEN, gate-on and gate-off voltages VON and VOFF, a common voltage VCOM, and a gamma voltage VGMA.

The first driver 150 receives the control signal GCS from the timing controller 130, and receives the gate-on and gate-off voltages VON and VOFF and the common voltage VCOM from the power supply 140. For example, the first driver 150 outputs a gate voltage VGATE, to be supplied to the first conductive line 210, to the output terminal unit 170 according to the first conductive line 210 control signal GCS so as to turn on/off the thin film transistor 240 connected to the first conductive line 210.

The second driver 160 provides to the second conductive line 220 the control signal DCS and the pixel data DATA from the timing controller 130 and the gamma voltage VGMA for displaying gradation of the pixel data DATA from the power supply 140. For example, in case of displaying images using the electro-optic layer 270, the second driver 160 supplies data voltage VDATA to the output terminal unit 170 to supply to the second conductive line 220 a positive, negative, or ground level voltage suitable for the second conductive line 220 control signal DCS according to characteristics of the electro-optic layer 270. That is, the second driver 160 may supply to the output terminal unit 170, for example, a +15V, −15V, or ground level voltage which is required for moving the charged color particles 271 and 272 of the electro-optic layer 270.

The output terminal unit 170 is formed of an output terminal of the first driver 150 and an output terminal of the second driver 160. Here, the output terminals are alternately disposed, and are formed in pairs toward a same direction. For example, in the output terminal unit 170, a first output terminal to an nth output terminal of the first driver 150 and the second driver 160 are alternately disposed. Here, the output terminal unit 170 has a fine pitch between the output terminals of the first and second drivers 150 and 160 so as to connect the terminals to the first and second conductive lines 210 and 220, respectively.

Accordingly, the first conductive line 210 may be connected to the driving IC 100 in the shortest distance on the substrate to minimize the forming region and resistance of the conductive line 210. In addition, in case it is difficult in the output terminal unit 170 to form the terminals in a fine pitch, the output terminals of the first and second drivers 150 and 160 may alternately be formed in two layers. For example, the output terminals of the first driver 150 may be disposed in a lower layer, and the output terminals of the second driver 160 may be disposed in an upper layer. This output terminal unit 170 outputs a gate voltage VGATE to the first conductive line GL, and outputs a data voltage VDATA to the second conductive line DL.

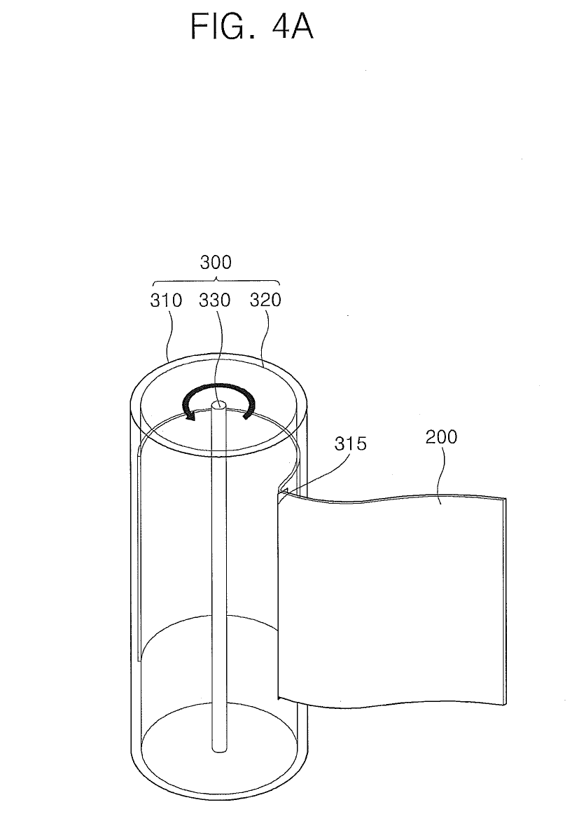

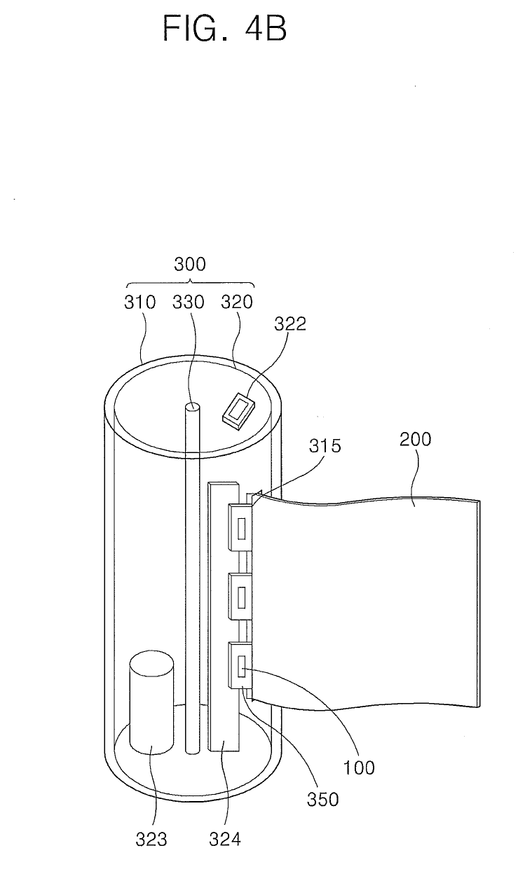

FIG. 4A and FIG. 4B are views illustrating the electro-optic display device according to another exemplary embodiment of the present disclosure.

As shown in FIG. 4A and FIG. 4B, the electro-optic display device comprises a substrate 200, a driving IC 100 and a holder 300.

The substrate 200 includes the electro-optic layer as shown in the display device of FIG. 2. Since the substrate 200 has been described hereinabove with reference to FIG. 1 and FIG. 2, its detailed description is omitted. The driving IC 100 is mounted on a connecting substrate 350 which is formed of a film. Here, the driving IC 100 is same as that of FIG. 3, and its description is omitted.

The holder 300 is formed to contain the substrate 200, and is connected to the substrate 200 through the connecting substrate 350 and the driving IC 100. Specifically, the holder 300 is formed in a cylinder shape so as to accommodate the substrate 200 in a rolled configuration. Here, the holder 300 includes a first case 310, a second case 320 and a rotation supporting axis 330.

The first case 310 may be formed of a hollow cylinder. In addition, the first case 310 includes a slit 315 having a same size as a width of the substrate 200 so as to facilitate a movement of the substrate 200. The second case 320 is formed in a similar shape to the first case 310 so as to be inserted into the first case 310. In addition, the second case 320 has a shape which allows its rotation about the rotation supporting axis 330. The second case 320 has a lengthwise hole so as to allow the rotation supporting axis 330 to be inserted. The rotation supporting axis 330 is formed in a cylinder shape having a smaller diameter than the hole of the second case 320. Although a line shows a contact surface between the rotation supporting axis 330 and the second case 320, the contact surface may be a hollow space according to diameters of the axis and the case. The second case 320 rotates counterclockwise about the rotation supporting axis 330 to wind the substrate 200, and rotates clockwise about the axis clockwise to unwind the substrate 200. Otherwise, the operation may be performed in the opposite direction.

The second case 320 and the rotation supporting axis 330 may be formed integrally, thereby rotating the second case 320 by rotating the rotation supporting axis 330. Here, the rotation may be performed easily by disposing an auxiliary means for facilitating rotation such as a grip to the rotation supporting axis 330.

As shown in FIG. 4B, a signal input/output terminal 322 is disposed on the second case 320, and a power supply 323 and a control board 324 are disposed in the second case 320. Here, FIG. 4B is a perspective view of an internal structure of the first and the second case 320. Data which a user wants to display through the substrate 200 is applied to the signal input/output terminal 322. For example, the signal input/output terminal 322 may be formed of a connector which operates in a universal serial bus (USB) method, and performs data input/output with an external unit such as computer.

The power supply 323 has a shape for being inserted into the second case 320 so as to supply power to the control board 324. The power supply 323 may use a cylinder battery for portability and acceptance. The power supply 323 may use a differently shaped battery as well as the cylinder battery.

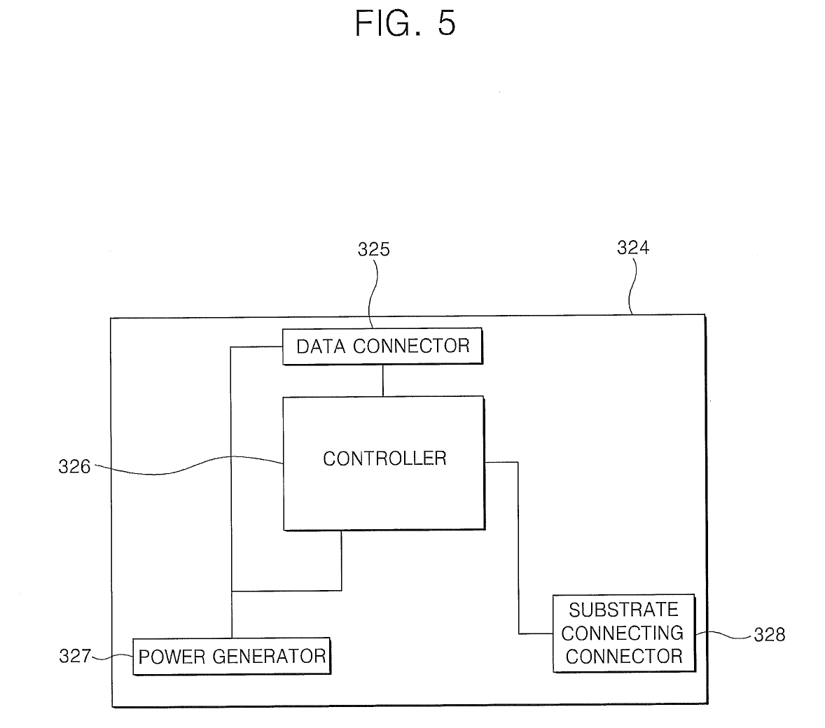

The control board 324 may be formed, for example, of a printed circuit board (PCB). The control board 324 will now be described in detail with reference to FIG. 5.

FIG. 5 is a view illustrating the control board shown in FIG. 4B.

As shown in FIG. 5, the control board 324 includes a data connector 325, a controller 326, a power generator 327 and a substrate connecting connector 328.

The data connector 325 is connected to the signal input/output terminal 322 and receives data from the external unit to apply the data to the controller 326 or output data stored in the controller 326 by request. The controller 326 includes a memory for storing data, and provides a signal for driving the substrate 200. This controller 326 functions as a central processing unit of a computer. The power generator 327 receives power for producing a voltage and a signal from the power supply 323, and provides a voltage to the controller 326 and the connector 328 required to drive the substrate 200.

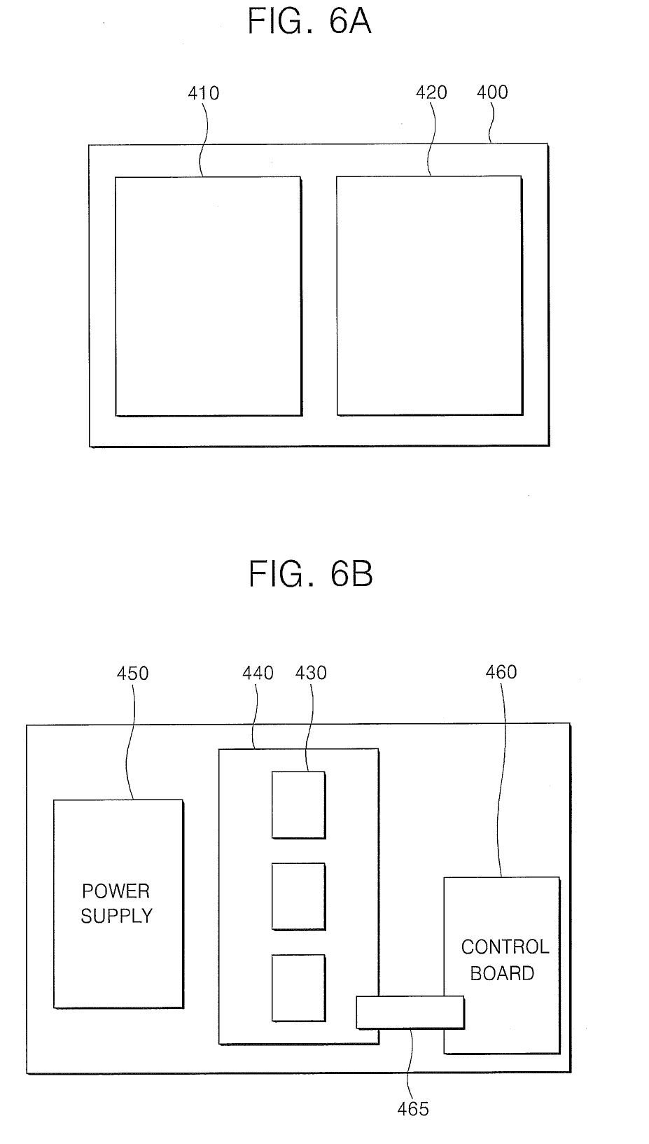

Hereinafter, the electro-optic display device is described according to another exemplary embodiment of the present disclosure with respect to FIG. 6A and FIG. 6B.

FIG. 6A and FIG. 6B are views illustrating a front side and a back side of the electro-optic display device, respectively, according to another exemplary embodiment of the present disclosure.

As shown in FIG. 6A and FIG. 6B, the electro-optic display device includes a first substrate 410, a second substrate 420, a connecting substrate 440, a driving IC package 430, a power supply 450, a control board 460, and a connector 465.

The first substrate 410 and the second substrate 420 comprise the electro-optic layer similar to the display device of FIG. 2. Here, the first substrate 410 and the second substrate 420 are formed of the same structure as the display device in FIG. 2.

The connecting substrate 440 is formed between the first substrate 410 and the second substrate 420 to connect the substrates 410 and 420 to each other. The driving IC package 430 is mounted on a surface or both surfaces of the connecting substrate 440. The connecting substrate 440 is formed of a flexible printed circuits board (FPCB) so as to allow the first substrate 410 and the second substrate 420 to bendably face each other. In addition, the connecting substrate 440 has a conductive line so as to provide a driving signal of the driving IC package 430 to the first substrate 410 and the second substrate 420.

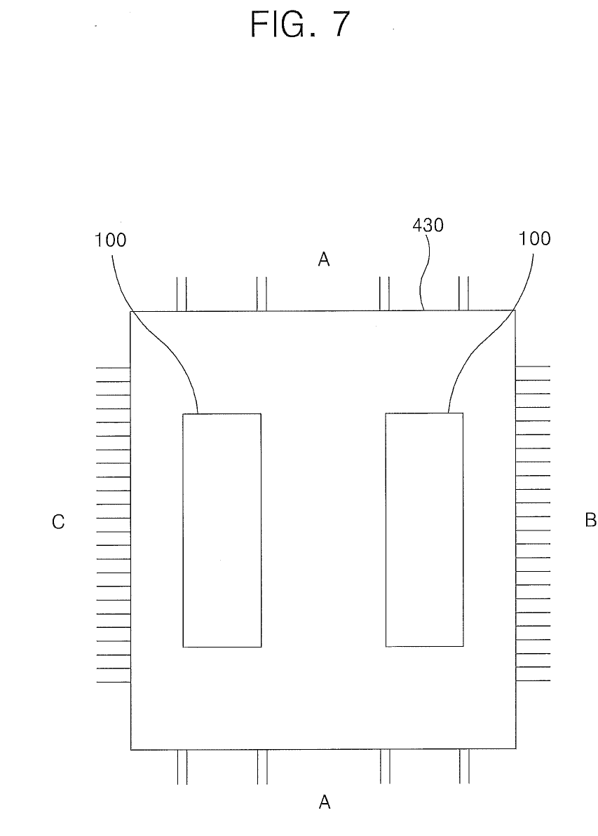

The driving IC package 430 is formed on one side of the connecting substrate 440. For example, the driving IC package 430 may be mounted on one side of the connecting substrate 440 in a shape of a tape carrier package. Here, the driving IC package 430 outputs a driving signal to both sides (e.g., right and left) so as to apply the driving signal to the first substrate 410 and the second substrate 420. The driving IC package 430 will now be described with reference to FIG. 7.

FIG. 7 is a view illustrating the driving IC package shown in FIG. 6B in detail.

The driving IC package 430 has output terminals at both edges (e.g., right and left) so as to apply a driving signal to the first and second substrates. 410 and 420. The driving IC package 430 may have two or more driving ICs 100. Here, the driving IC 100 has the output terminal unit identical to the driving IC of FIG. 3. The driving IC package 430 receives pixel data and a control signal A from the control board 460 to output a first substrate driving signal B to an output terminal at an edge of driving IC package 430. In addition, the driving IC package 430 receives the pixel data and the control signal from the control board 460 to output a second substrate driving signal C to an output terminal at another edge of driving IC package 430. Here, the driving IC package 430 is formed at a back side of the first and second substrates 410 and 420. The driving IC package 430 has the terminal for the first substrate driving signal B at its right edge side, and has the terminal for the second substrate driving signal C at its left edge side. However, in case the driving IC package 430 is formed at a front side of the first and second substrates 410 and 420, and the package may have the terminal for the first substrate driving signal B at its left edge side, and has the terminal for the second substrate driving signal C at its right edge side.

The power supply 450 is formed in a battery shape at a rear side of the first substrate 410 and the second substrate 420 so as to improve portability of the display device. The power supply 450 supplies power for driving the first and second substrates 410 and 420 to the control board 460.

The control board 460 is connected to the driving IC package 430 through the connector 465 and the connecting substrate 440. In addition, the control board 460 supplies, to the driving IC package 430, pixel data, a control signal and power for driving the first and second substrates 410 and 420. To this end, the control board 460 produces a voltage from the power supplied from the power supply 450 and applies the voltage to the driving IC package 430.

The connector 465 is formed of conductive lines so as to supply to the connecting substrate 440 the pixel data, the control signal, and the power for driving the first and second substrates 410 and 420 which are provided from the control board 460.

Here, the display device may include a base substrate 400 to which the first substrate 410 and the second substrate 420 are attached. The base substrate 400 is attached to the first substrate 410 and the second substrate 420 at one side, and is attached to the connecting substrate 440, the power supply 450 and the control board 460 at the other side. The base substrate 400 may be bent at a center region to obtain a folder shape.

As described above, the electro-optic display device according to the exemplary embodiment of the present disclosure has a driving IC formed at one side of a substrate and the substrate is wound around the interior of a holder, thereby improving portability. In the electro-optic display device according to another exemplary embodiment of the present disclosure, a driving IC package is mounted on a flexible connecting substrate which connects two substrates, so that the electro-optic display device is foldable like a paper book and an image is displayed at front and back sides of the display device.

While the disclosure has been shown and described with reference to a certain exemplary embodiment thereof, it will be understood by those skilled in the art that various changes in form and details may be made therein without. departing from the spirit and scope of the disclosure as defined by the appended claims.

What is claimed is:

1. An electro-optic display device comprising:
a substrate including an electro-optic layer having charged color particles and including a gate line and a data line;
a timing controller to generate a control signal according to an externally applied signal; and
a driving integrated circuit disposed on one side of the substrate, the driving integrated circuit having a gate driver and a data driver to receive the control signal from the timing controller and to respectively drive the gate line and the data line.

2. The device according to claim 1, wherein the driving integrated circuit further comprises an output terminal unit for outputting signals of the gate driver and the data driver.

3. The device according to claim 2, wherein the output terminal unit comprises output terminals of the gate driver and the data driver which are alternately disposed, and the output terminals output signals in a same direction.

4. The device according to claim 3, wherein the gate line comprises a connection line to be connected to the output terminal unit.

5. The device according to claim 1, wherein the driving integrated circuit further comprises a power supply to supply power to the timing controller, the gate driver, and the data driver.

6. The device according to claim 5, wherein the power supply outputs a positive gamma voltage, a negative gamma voltage and a ground level gamma voltage to the data driver.

7. The device according to claim 1, wherein the driving integrated circuit further comprises a receiving unit to receive a signal from an external unit to transmit the signal to the timing controller.

8. The device according to claim 1, further comprising a holder to receive the substrate and the driving integrated circuit.

9. The device according to claim 8, wherein the holder comprises a first case having a cylindrical shape, a second case formed within the first case, and a rotation supporting axis to rotate the second case.

10. The device according to claim 9, wherein the holder comprises a control board connected to the driving integrated circuit, and a power supply to supply power to the control board and the driving integrated circuit.

11. The device according to claim 10, wherein the control board comprises a controller to receive data and a voltage from an external unit and to control an operation of the substrate and an image displayed on the substrate.

12. The device according to claim 11, wherein the holder comprises a signal input/output terminal to be connected to the external unit.

13. The device according to claim 10, wherein the power supply comprises a battery.

14. An electro-optic display device comprising:
first and second substrates having a gate line and a data line;
a connection substrate formed between the first and second substrates; and
a driving integrated circuit package mounted on the connection substrate and adapted to have two or more driving integrated circuits each including a gate driver and a data driver which respectively drive the gate line and the data line.

15. The device according to claim 14, further comprising a control board to provide pixel data and a control signal to the driving integrated circuit package.

16. The device according to claim 15, wherein the driving integrated circuit package receives the pixel data and the control signal from the control board to output driving signals to drive the first substrate and the second substrate respectively.

17. The device according to claim 15, further comprising a connector to provide connection between the control board and the driving integrated circuit package.
